(19) United States
(12) Patent Application Publication
(10) Pub. No.: US 2025/0190867 A1
(43) Pub. Date: Jun. 12, 2025

(54) METHOD, APPARATUS AND SYSTEM OF IMPROVING ACCURACY OF ARTIFICIAL INTELLIGENCE LEARNING-BASED PREDICTIVE RESULTS

(71) Applicant: Andong National University Industry-Academic Cooperation Foundation, Andong-si (KR)

(72) Inventor: Ki Hyun JUNG, Andong-si (KR)

(73) Assignee: Andong National University Industry-Academic Cooperation Foundation, Andong-si (KR)

(21) Appl. No.: 18/954,069

(22) Filed: Nov. 20, 2024

(30) Foreign Application Priority Data
Dec. 8, 2023 (KR) 10-2023-0177213

(51) Int. Cl. G06N 20/00

(52) U.S. Cl. CPC G06N 20/00

(57) ABSTRACT

Proposed are method, apparatus, and system for improving accuracy of artificial intelligence learning-based predictive results. The method for improving accuracy of artificial intelligence learning-based predictive results include configuring an input dataset by collecting and preprocessing data for artificial intelligence learning, creating an artificial intelligence model by repeatedly learning on the basis of the input dataset, and driving and providing a predictive result for a target object in input data using the artificial intelligence model. In the method, in the creating of an artificial intelligence model, a first object and a second object are distinguished in the input dataset and preprocessing information of the first object is used in a repeated learning process for the second object.

### CROSS REFERENCE TO RELATED APPLICATION

The present application claims priority Patent Applications No. 10-2023-0177213, filed on Dec. 8, 2023, the entire contents of which are incorporated herein for all purposes by this reference.

### STATEMENT REGARDING GOVERNMENT SPONSORED RESEARCH

This invention was supported by the National Research Foundation of Korea (NRF) funded by the Ministry of Education. [Research Project name: “Basic Science Research Program”; Research Subject name: “Multimedia Contents Protection and Verification Platform using Blockchain”; Project Serial Number: 1345363759; Research Subject Number: 2021R1I1A3049788]

### BACKGROUND OF THE DISCLOSURE

### 1. Field of the Disclosure

The present disclosure relates to a method and apparatus for improving accuracy of artificial intelligence learning-based predictive results and, in more detail, a method and apparatus for improving predictive accuracy by repeatedly using information derived from correlation analysis on given data (texts, images, audio, video, metadata, etc.) during a learning process.

### 2. Description of the Related Art

Research and development on artificial intelligence technologies such as machine learning and deep learning are actively being conducted. These research outcomes are being applied as various technologies across various industries, so it is expected that they will be utilized in all fields in the future.

These artificial intelligence technologies involve continuous efforts and research to develop highly accurate models through learning within specific applications, and to generate highly accurate predictive results using the created models.

### SUMMARY OF THE DISCLOSURE

In order to solve the problems described above, an objective of the present disclosure is to provide a method and apparatus for improving the accuracy of a predictive result derived on the basis of information derived from data given in a learning process by using the information in learning.

In order to achieve the objectives described above, a method for improving accuracy of artificial intelligence learning-based predictive results according to at least one of various embodiments of the present disclosure includes: configuring an input dataset by collecting and preprocessing data for artificial intelligence learning; creating an artificial intelligence model by repeatedly learning on the basis of the input dataset; and driving and providing a predictive result for a target object in input data using the artificial intelligence model. In the method, in the creating of an artificial intelligence model, a first object and a second object are distinguished in the input dataset and preprocessing information of the first object is used in a repeated learning process for the second object.

Correlation information between the first object and the second object may be included in the preprocessing information of the first object.

The correlation information may include at least one of correlation information based on tag information for texts or images included in the input dataset, correlation information for an entire scene and an object in one frame, and correlation information between frames.

The preprocessing information of the first object may be used only when a repeated learning result for the second object is less than a first threshold.

The artificial intelligence model may be created only when a repeated learning result for the second object is a second threshold or more. The first threshold and the second threshold may be the same or different from each other.

An apparatus for improving accuracy of artificial intelligence learning-based predictive results according to at least one of various embodiments of the present disclosure includes: a memory configured to store an artificial intelligence model; and a processor configured to configure an input dataset by collecting and preprocessing data for artificial intelligence learning, create an artificial intelligence model by repeatedly learning on the basis of the input dataset, and derive and provide a predictive result for a target object in input data using the artificial intelligence model. The processor may distinguish between a first object and a second object in the input dataset and create the artificial intelligence model using preprocessing information of the first object in a repeated learning process for the second object.

Correlation information between the first object and the second object may be included in the preprocessing information of the first object.

The processor may create correlation information including at least one of correlation information based on tag information for texts or images included in the input dataset, correlation information for an entire scene and an object in one frame, and correlation information between frames.

The processor may use the preprocessing information of the first object only when a repeated learning result for the second object is less than a first threshold.

The processor may create the artificial intelligence model only when a repeated learning result for the second object is a second threshold or more. The processor may set first threshold and the second threshold to be the same or different from each other.

A system for improving accuracy of artificial intelligence learning-based predictive results according to at least one of various embodiments of the present disclosure includes: an input device configured to transmit and receive input data; and an output device configured to provide a predictive result for the input data, wherein the output device includes: a memory configured to store an artificial intelligence model; and a processor configured to configure an input dataset by collecting and preprocessing data for artificial intelligence learning, create an artificial intelligence model by repeatedly learning on the basis of the input dataset, and derive and provide a predictive result for a target object in input data using the artificial intelligence model, wherein the processor distinguishes between a first object and a second object in the input dataset and creates the artificial intelligence model using preprocessing information of the first object in a repeated learning process for the second object.

According to at least one of various embodiments of the present disclosure, there are the following effects.

First, there is an advantage that it is possible to improve accuracy of a predictive result derived for input data through an artificial intelligence model, that is, an object detection rate.

Second, there is an advantage that it is possible to use the present disclosure in various fields such as monitoring of emergency situations and detection of illegal drugs and illegal weapons that may cause social problems.

### BRIEF DESCRIPTION OF THE DRAWINGS

FIG. 1 is a schematic diagram of a system for improving accuracy of artificial intelligence learning-based predictive results according to an embodiment of the present disclosure;

FIG. 2 is a configuration block diagram of the processor of FIG. 1;

FIG. 3 is a flowchart shown to describe a method for improving accuracy of artificial intelligence learning-based predictive results according to an embodiment of the present disclosure;

FIG. 4 is a diagram shown to describe the entire process of performing the method of FIG. 3.

FIGS. 5A to 6D are diagrams shown to describe an object detection method according to the present disclosure.

### DESCRIPTION OF THE PREFERRED EMBODIMENTS

Hereinafter, some embodiments of the present disclosure are described in detail with reference to exemplary drawings. It should be noted that when components are given reference numerals in the drawings, the same components are given the same reference numerals even if they are shown in different drawings. In the following description of embodiments of the present disclosure, when detailed description of well-known configurations or functions is determined as interfering with understanding of the embodiments of the present disclosure, the detailed description is omitted.

Machine learning refers to a field that defines various problems addressed in the artificial intelligence domain and studies the methodologies for solving them.

An Artificial Neural Network (ANN), which is a model that is used in machine learning, may mean a general model that is composed of artificial neurons (nodes) forming a network through coupling of synapses and has an ability to solve problems. An ANN may be defined by connection patterns among neurons in different layers, a learning process that updates model parameters, and an activation function that creates output values.

An ANN may include an input layer, an output layer, and selectively one or more hidden layers. Each of the layers may include one or more neurons and the ANN may include synapses connecting neurons to one another. The neurons in an ANN can output input signals, weights, and function values of the activation function about bias that are input through the synapses.

The model parameters refer to parameters that are determined through learning and include weights of synapse connection, bias of neurons, etc. Further, hyper-parameters, which refer to parameters that have to be set before learning in a machine learning algorithm, may include a learning rate, the number of times of repetition, a mini-batch size, an initialization function, etc.

The object of training an ANN may be considered as determining model parameters that minimize a loss function. The loss function can be used for an index for determining an optimum model parameter in a training process of an ANN.

Machine learning can be classified into supervised learning, unsupervised learning, reinforcement learning, etc. in accordance with the types of learning.

Supervised learning refers to a method that trains an ANN with labels given to learning data, in which the label may refer to a correct answer (or a resultant value) that the ANN has to infer when learning data is input to the ANN. Unsupervised learning may refer to a method of training an ANN without labels given to learning data. Reinforcement learning may refer to a training method of training an agent defined in a certain environment to select activities or an activity order that maximizes accumulated compensation in each state.

Machine learning that is achieved through a Deep Neural Network (DNN) including a plurality of hidden layers of ANNs is also called deep learning, which is a subset of machine learning.

The present disclosure provides a method and apparatus for improving the accuracy of a predictive result derived on the basis of information derived from data given in a learning process by using the information in learning. In particular, texts may include not only general text data that is used as input data, but also all of tag information included in multimedia data and information that can be obtained in a preprocessing process. Further, all of data used as input in artificial intelligence may be included such as using the information of objects themselves in audio, images, video, metadata, etc. or converting and using data into a text format.

It is possible to increase the accuracy in detection of objects by using information obtained in a preprocessing process as correlation information for objects that are difficult to accurately detect in an input dataset. There is provided a method and apparatus for improving the detection rate of objects or information to be found by reusing information around objects as input data for artificial intelligence learning for objects difficult to detect through the above process.

In relation to the present disclosure, as a method that can increase the accuracy of predictive results that are derived using the artificial intelligence technology, there may be a method of using high-quality big data in an input dataset that is used for learning and a method of creating a new model through various algorithms and layers (input layer, hidden layer, and output layer) in a learning process.

Hereafter, the present specification discloses various embodiments that can improve accuracy, for example, by using information, which is derived from data given in a learning process, for leaning.

In this case, the data given in a learning process may include, for example, texts, metadata, images, audio, etc., and the images may refer to both still images and videos.

Meanwhile, in the present disclosure, in order to increase the accuracy of a predictive result of an artificial intelligence model, it is possible to perform correlation analysis on data given in a learning process described above and use the result of the correlation analysis in learning.

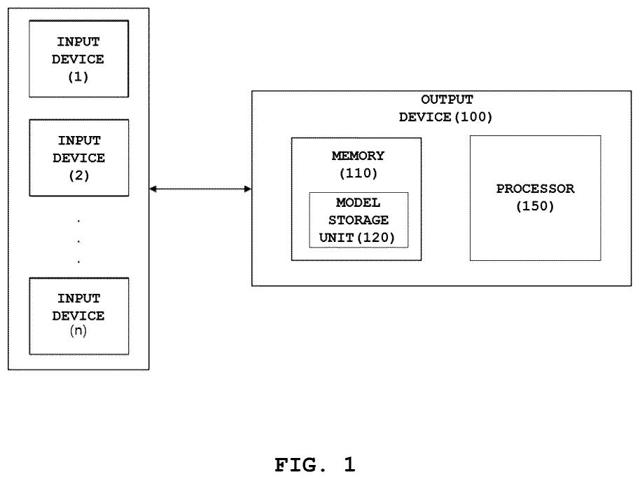

FIG. 1 is a schematic diagram of a system for improving accuracy of artificial intelligence learning-based predictive results according to an embodiment of the present disclosure.

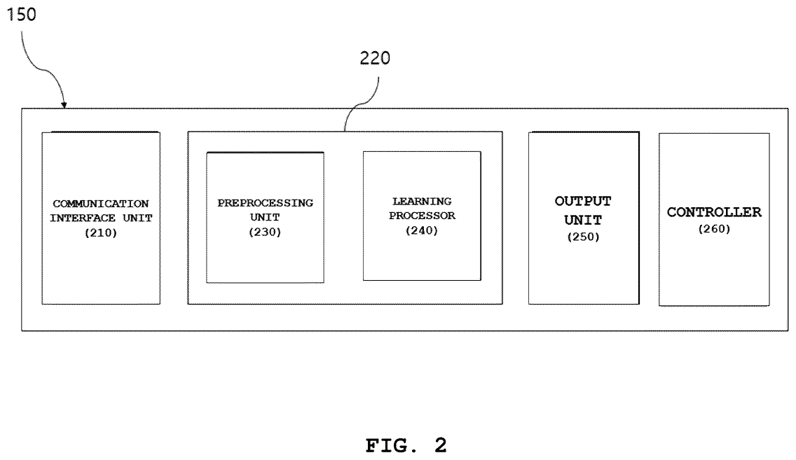

FIG. 2 shows an exemplary configuration block diagram of the processor of FIG. 1.

Referring to FIG. 1, a system for improving accuracy of artificial intelligence learning-based predictive results may include an input device and an output device 100.

The input device may include all types of devices that input data to be input to an artificial intelligence model.

In FIG. 1, n input devices are shown (where n is a natural number). In the specification, even though described simply as an input device, it may refer to singular or plural, which may be determined by the context.

Such an input device may be a fixed terminal type such as a PC, a TV, and a signage, a mobile terminal type such as a smartphone, a tablet PC, and a laptop, and a wearable terminal type such as a smart watch and smart glasses. Further, such an input device may be a dedicated device type capable of data input in linkage with the output device 100.

The output device 100 may include all types of devices that provide a predict result for data input from the input device (i.e., input data).

Such an output device 100, depending on embodiments, may be in the form of hardware such as a server and a device, combined with software such as an artificial intelligence program.

The output device 100 according to an embodiment of the present disclosure may be composed of a memory 110 and a processor 150.

The memory 110 may include a model storage unit 120 storing an artificial intelligence model.

It is exemplarily shown in FIG. 1 that the memory 110 is provided in the output device 100, but the present disclosure may not be limited thereto. For example, the memory 110 (or the model storage unit 120) may be located remotely, implemented in the form of a DB, and linked with the output device 100 through a network.

The processor 150 can configure an input dataset by collecting and preprocessing data for artificial intelligence learning.

The processor 150 can create an artificial intelligence model by repeatedly learning using the configured input dataset.

The processor 150 can derive and provide a predictive result for data that is input by the input devices (1 to n), using the created artificial intelligence model.

The processor 150 can provide the derived predictive result through an output interface unit. The output interface unit may be, for example, an output unit 250 in the output device 100 shown in FIG. 2 or a separate output unit remotely located.

When an output unit is remotely located, the processor 150 can process and convert the predictive result derived by the artificial intelligence model into a form that can be output through the output unit, and can control providing and outputting through a network.

Referring to FIG. 2, more detailed description of the processor 150 is as follows.

The processor 150 may include a communication interface unit 210, an artificial intelligence engine 220, an output unit 250, a controller 260, etc.

The communication interface unit 210 can support a communication environment between the processor 150 and the outside.

The communication interface unit 210 can support various communication protocols for data transmission and reception.

The communication interface unit 210 can collect various data from the outside to configure an input dataset for creating an artificial intelligence model. The collected data can be transmitted to the artificial intelligence engine 220.

The artificial intelligence engine 220 may include a data preprocessor 230, a learning processor 240, etc.

The data preprocessor 230 can perform a preprocessing operation of preprocessing data collected by the communication interface unit 210 into data that can be processed by the learning processor 240.

The learning processor 240 can configure an input dataset from the data preprocessed by the data preprocessor 230 and perform artificial intelligence learning using the configured input dataset.

The learning processor 240 can create an artificial intelligence model through artificial intelligence learning.

The learning processor 240 can distinguish between a first object and a second object in the input dataset. The learning processor 240 can create the artificial intelligence model using preprocessing information of the first object in a repetitive learning process for the second object.

The processor 150 or the learning processor 240 can extract input features as preprocessing for input data.

The learning processor 240 can train a model consisting of an artificial neural network using training data. In this case, the trained artificial neural network may be referred to as a model. The model can be used to infer resultant values for new input data rather than training data and the inferred values can be used as a basis of determination for performing certain operations.

The output unit 250 includes various output interfaces such as a display, a speaker, etc., and can provide a predictive result by an artificial intelligence model, etc.

The controller 260 can control general operation of the output device 100, including the operations of the components of the processor 150.

Hereafter, more detailed description of improvement in accuracy of an artificial intelligence learning-based predictive result according to an embodiment of the present disclosure is as follows.

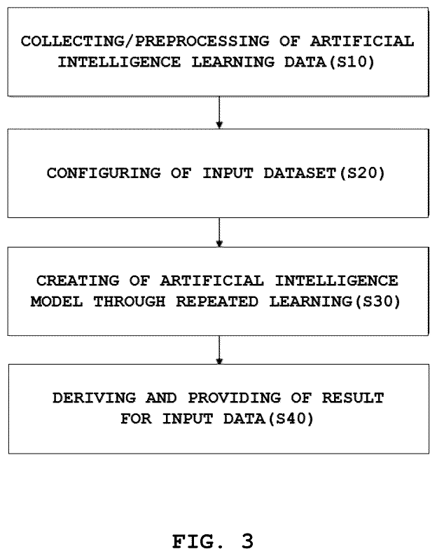

FIG. 3 is a flowchart shown to describe a method for improving accuracy of artificial intelligence learning-based predictive results according to an embodiment of the present disclosure.

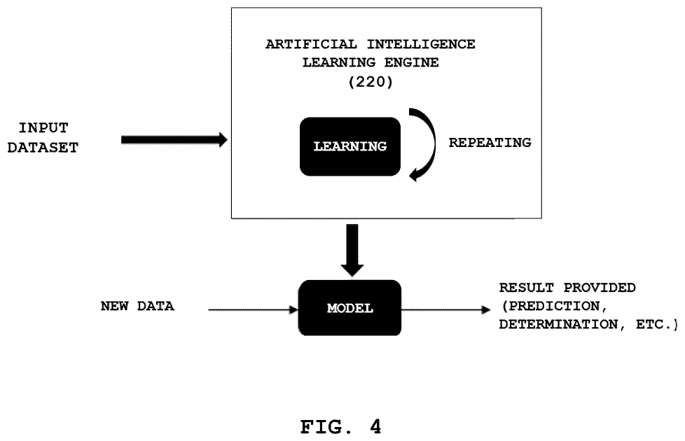

FIG. 4 is a diagram shown to describe the entire process of performing the method of FIG. 3.

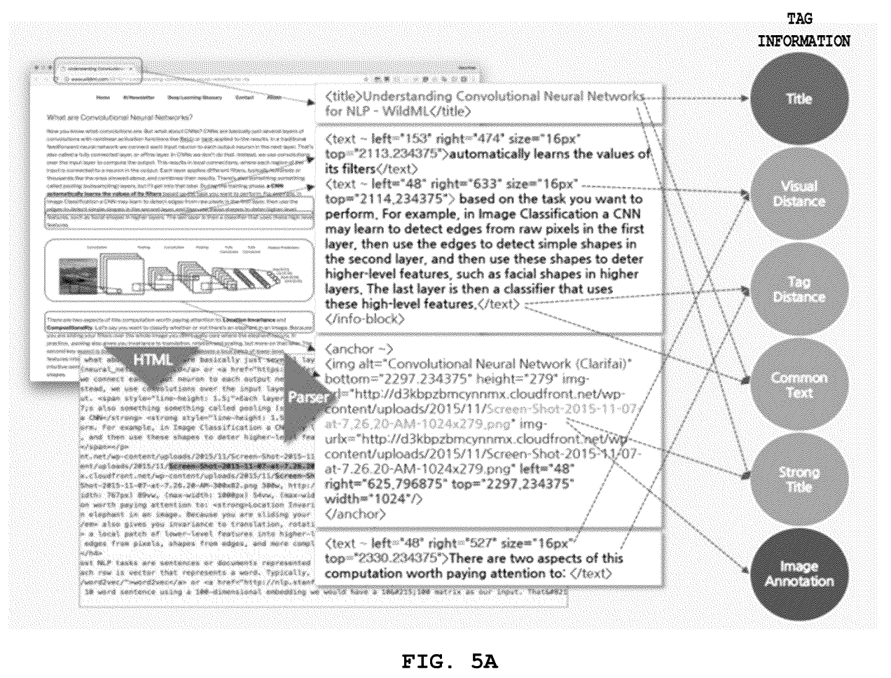

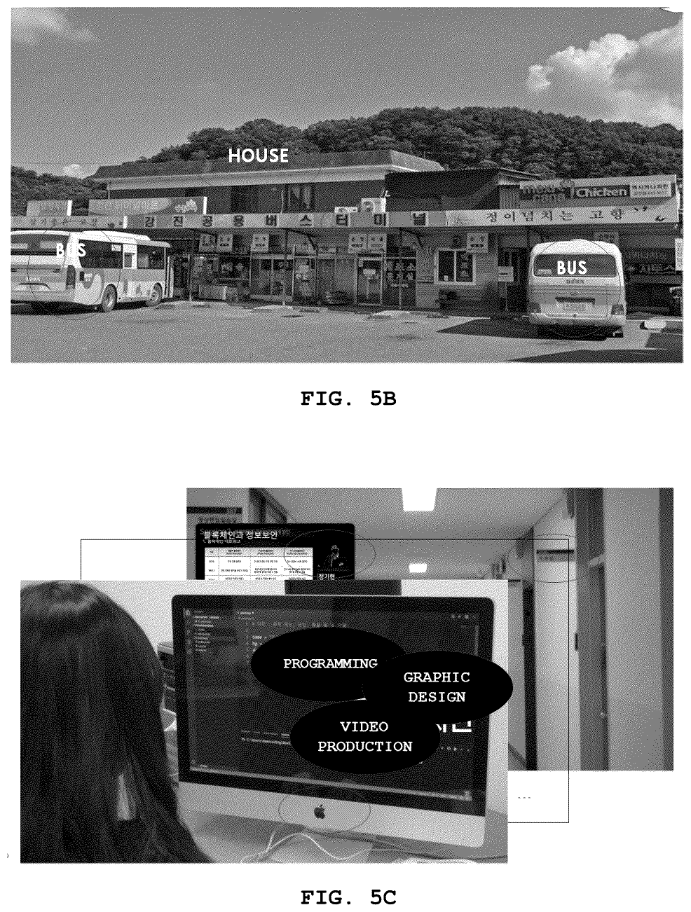

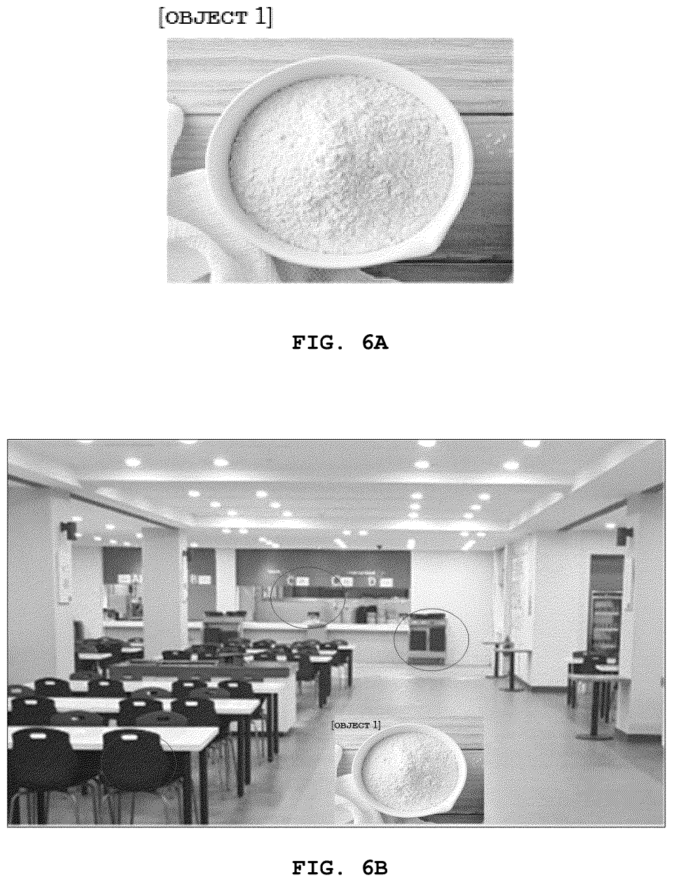

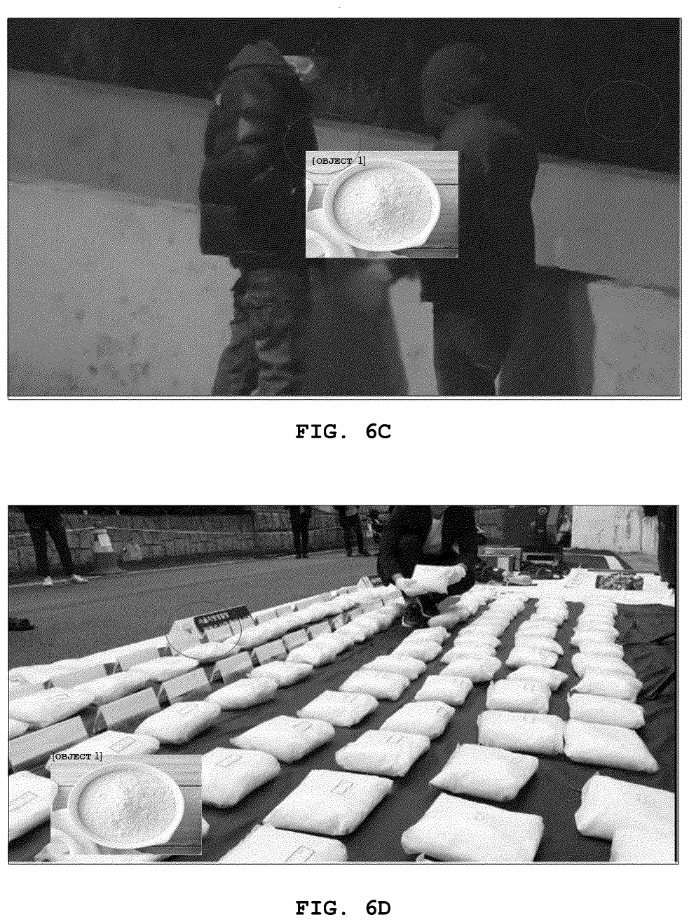

FIGS. 5A to 6D are diagrams shown to describe an object detection method according to the present disclosure.

Referring to FIG. 3, the processor 150 can collect and preprocess data for artificial intelligence learning (S10).

The processor 150 can configure an input dataset from the preprocessed data (S20).

The processor 150 can create an artificial intelligence model by repeatedly learning on the basis of the input dataset (S30).

The processor 150 can derive and provide a predictive result for the input data using the artificial intelligence model (S40).

In the operation of S40, the derived predictive result may, for example, include a predictive result for a target object in the input data.

The processor 150, in the operation of S30, can distinguish a first object and a second object in the input dataset and can create an artificial intelligence model using preprocessing information of the first object in a repeated learning process for the second object.

In the present disclosure, the first object, for example, may be an object that is accurately detected in a preprocessing process. On the contrary, the second object, unlike the first object, may be an object that is not accurately detected in a preprocessing process.

In the above description, correlation information between the first object and the second object may be included in the preprocessing information of the first object.

Further, the correlation information may include at least one of correlation information based on tag information for texts or images included in the input dataset, correlation information for the entire scene and an object in one frame, and correlation information between frames.

In the above description, the preprocessing information of the first object can be used only when the repeated learning result for the second object is less than a first threshold.

Further, in the above description, the artificial intelligence model can be created only when the repeated learning result for the second object is a second threshold or more. In this case, the first threshold and the second threshold may be the same or different from each other.

In the present disclosure, in particular, texts may include not only general text data that is used as input data, but also all of tag information included in multimedia data and tag information that can be obtained in a pre-processing process.

Further, in the present disclosure, all of data used as input in artificial intelligence may be included such as using the information of objects themselves in audio, images, video, etc. or converting and using data into a text format.

In particular, in the present disclosure, it is possible to improve accuracy in object detection through the artificial intelligence model shown in FIG. 4 created using information, which is obtained in a preprocessing process for an object difficult to accurately detect from an input dataset, that is, the second object. Further, it is possible to improve an object detection rate for the second object difficult to detect through the above process by using information around the second object (e.g., information accurately detected for the first object) as input data for artificial intelligence leaning.

Referring to FIG. 4, the entire process according to the present disclosure, for example, may be as follows.

The artificial intelligence learning engine 220 of the processor can learn a process of distinguishing an object for the second object with relatively low accuracy (e.g., an object not detected as a specific object in learning) through the correlation with a surrounding object (one scene and continuous scenes both available) by repeatedly using first object information with high accuracy in the next learning process of repeated learning processes.

The artificial intelligence learning engine 220, for example, can find out first a first object that can be accurately found out first from an input dataset and can perform repeated learning for an unclear object (second object) using the information of the first object as input data for learning, that is, an input dataset.

Accordingly, the artificial intelligence learning engine 220 can accurately detect an object using the correlation between objects, the correlation between the entire scene and an object, the correlation between objects or a scene and an object in front/rear or continuous scenes, etc.

As described above, the artificial intelligence learning engine 220, for one object, can distinguish between an object that can be primarily and accurately predicted and an object difficult to distinguish.

The artificial intelligence learning engine 220 can improve predictive accuracy of a non-detected or unclear object by using object detection information as information for distinguishing a non-detected object in a preprocessing process.

In the above description, the surrounding information that is used to distinguish an object difficult to distinguish, for example, may refer to FIGS. 5A to 5C.

Referring to FIG. 5A to 5C, the artificial intelligence learning engine 220 can give support to be able to learn various data, including tag information included in multimedia data, as described above, on the basis of text, image, audio, video, etc. information.

The artificial intelligence learning engine 220 can obtain correlation information, for example, using tag information about texts and images shown in FIG. 5A.

The artificial intelligence learning engine 220 can use, for example, the information about objects included in the still image shown in FIG. 5B, as correlation information.

The artificial intelligence learning engine 220 can use, for example, the information in one frame of a video shown in FIG. 5C, as correlation information.

Meanwhile, the artificial intelligence learning engine 220 can use, for example, the inter-frame information of a plurality of frames of a video shown in FIG. 5C, as correlation information.

The artificial intelligence learning engine 220 can use combinations of the information shown in FIGS. 5A to 5C as correlation information.

The artificial intelligence learning engine 220 can provide a method of accurately finding out an object using information shown in a tag for a file having tag information.

The artificial intelligence learning engine 220, for learning data including continuous information such as a video, can improve accuracy by using the correlation for front and rear or several frames as information for detecting or predicting an object not detected or not distinguished in a learning process so far.

For example, when the artificial intelligence learning engine 220 makes determination for one object shown in FIG. 6A, like an artificial intelligence learning process, it may be difficult to accurately detect an object such as flour and an illegal drug in a primary learning process, so the artificial intelligence learning engine 220 performs repeated learning processes and uses the correlation with surrounding given objects in the processes. Accordingly, the probability of determining the object as flour in FIG. 6B and the object as an illegal drug in FIGS. 6C to 6D increases, so the accuracy can be improved.

In other words, when the artificial intelligence learning engine 220 detects a chair, a restaurant, a drink stand, etc. in a preprocessing process to accurately detect a corresponding object (object 1) in FIG. 6B, it may detect the object 1 as flour.

On the other hand, when the artificial intelligence learning engine 220 detects a place (a dark place, a secluded alley, a bus terminal, a club, a police station, a dock, an airport, etc.), money (cash, a bundle of cash, an envelope, etc.), etc. in a preprocessing process in FIG. 6C, the probability of determining the object 1 as flour decreases in comparison to FIG. 6B, and in this case, instead, the probability of determining the object 1 as an illegal drug increases.

Further, in FIG. 6D, the probability of determining the object 1 as an illegal drug rather than flour on the basis of a preliminary object detection result related to a job (police, journalist, lawyer, etc.), a place (a custom, a warehouse, etc.), etc. may increase.

According to at least one of the various embodiments of the present disclosure described above, it is possible to increase the accuracy of a predictive result derived for data that is input through an artificial intelligence model, that is, an object detection rate, and it is possible to use the increased accuracy of a predictive result in various fields such as monitoring of emergency situations such as a natural disaster, a fire, and an accident and detection of illegal drugs and illegal weapons that may cause social problems.

The above description merely explains the spirit of the present disclosure and the present disclosure may be changed and modified in various ways without departing from the spirit of the present disclosure by those skilled in the art. Accordingly, the embodiments described herein are provided merely not to limit, but to explain the spirit of the present disclosure, and the spirit of the present disclosure is not limited by the embodiments. The patent right of the present disclosure should be construed by the following claims and the scope and spirit of the disclosure should be construed as being included in the patent right of the present disclosure.

What is claimed is:

1. A method for improving accuracy of artificial intelligence learning-based predictive results, the method comprising:
configuring an input dataset by collecting and preprocessing data for artificial intelligence learning;
creating an artificial intelligence model by repeatedly learning on the basis of the input dataset; and
driving and providing a predictive result for a target object in input data using the artificial intelligence model,
wherein, in the creating of an artificial intelligence model, a first object and a second object are distinguished in the input dataset and preprocessing information of the first object is used in a repeated learning process for the second object.

2. The method of claim 1, wherein correlation information between the first object and the second object is included in the preprocessing information of the first object.

3. The method of claim 2, wherein the correlation information includes at least one of correlation information based on tag information for texts or images included in the input dataset, correlation information for an entire scene and an object in one frame, and correlation information between frames.

4. The method of claim 1, wherein the preprocessing information of the first object is used only when a repeated learning result for the second object is less than a first threshold.

5. The method of claim 1, wherein the artificial intelligence model is created only when a repeated learning result for the second object is a second threshold or more, and
the first threshold and the second threshold are the same or different from each other.

6. An apparatus for improving accuracy of artificial intelligence learning-based predictive results, the apparatus comprising:
a memory configured to store an artificial intelligence model; and
a processor configured to configure an input dataset by collecting and preprocessing data for artificial intelligence learning, create an artificial intelligence model by repeatedly learning on the basis of the input dataset, and derive and provide a predictive result for a target object in input data using the artificial intelligence model,
wherein the processor distinguishes between a first object and a second object in the input dataset and creates the artificial intelligence model using preprocessing information of the first object in a repeated learning process for the second object.

7. The apparatus of claim 6, wherein correlation information between the first object and the second object is included in the preprocessing information of the first object.

8. The apparatus of claim 7, wherein the processor creates correlation information including at least one of correlation information based on tag information for texts or images included in the input dataset, correlation information for an entire scene and an object in one frame, and correlation information between frames.

9. The apparatus of claim 6, wherein the processor uses the preprocessing information of the first object only when a repeated learning result for the second object is less than a first threshold.

10. The apparatus of claim 6, wherein the processor
creates the artificial intelligence model only when a repeated learning result for the second object is a second threshold or more, and
sets the first threshold and the second threshold to be the same or different from each other.

11. A system for improving accuracy of artificial intelligence learning-based predictive results, the system comprising:
an input device configured to transmit and receive input data; and
an output device configured to provide a predictive result for the input data,
wherein the output device comprises:
a memory configured to store an artificial intelligence model; and
a processor configured to configure an input dataset by collecting and preprocessing data for artificial intelligence learning, create an artificial intelligence model by repeatedly learning on the basis of the input dataset, and derive and provide a predictive result for a target object in input data using the artificial intelligence model,
wherein the processor distinguishes between a first object and a second object in the input dataset and creates the artificial intelligence model using preprocessing information of the first object in a repeated learning process for the second object.
